(19) United States
(12) Patent Application Publication
(10) Pub. No.: US 2026/0183941 A1
(43) Pub. Date: Jul. 2, 2026

(54) METHODS FOR CONTROLLING DEFORMABLE OBJECT INTERACTION BASED ON VISION-TACTILE-LANGUAGE-ACTION MULTIMODAL MODEL

(71) Applicant: TONGJI UNIVERSITY, Shanghai (CN)

(72) Inventors: Bin HE, Shanghai (CN); Yanmin ZHOU, Shanghai (CN); Qian XIE, Enshi (CN); Xingyu LI, Xinyang (CN); Rong JIANG, Shanghai (CN); Xin LI, Huaihua (CN)

(73) Assignee: TONGJI UNIVERSITY, Shanghai (CN)

(21) Appl. No.: 19/396,497

(22) Filed: Nov. 21, 2025

(30) Foreign Application Priority Data
Dec. 31, 2024 (CN) 202411975168.4

(51) Int. Cl. B25J 9/16; G06V 10/42; G06V 10/44; G06V 10/62; G06V 10/77; G06V 10/82

(52) U.S. Cl. CPC B25J 9/163; G06V 10/62; G06V 10/42; G06V 10/44; G06V 10/7715; G06V 10/82

(57) ABSTRACT

The present disclosure relates to a method for interaction operation control of a deformable object based on a vision-tactile-language-action multimodal model, including: encoding a visual image, tactile data, and language data for the deformable object to obtain a visual feature, a tactile feature, and a language feature, performing cross-modal feature alignment processing on the visual feature, the tactile feature, and the language feature to obtain a multimodal fusion feature, inputting the multimodal fusion feature into a large model for environment understanding, adopting a planning manner of ‘thinking-decision’ to iteratively perform action planning and execution, and repeating the above operation steps until an interaction operation task of the deformable object is completed.

### CROSS-REFERENCE TO RELATED APPLICATIONS

This application claims priority to Chinese Patent Application No. 202411975168.4, filed on Dec. 31, 2024, the contents of which are hereby incorporated by reference.

### TECHNOLOGICAL FIELD

The present disclosure relates to the field of intelligent robot interaction control technology, and in particular to a method for interaction operation control of a deformable object based on a vision-tactile-language-action multimodal model.

### BACKGROUND

An intelligent robotic system primarily relies on visual perception and tactile feedback to perform object grasping and manipulation tasks. Traditional visual perception techniques primarily employ computer vision techniques, such as a convolutional neural network, for object detection and recognition, which can provide efficient object localization information. However, when dealing with deformable objects in complex environments, traditional visual approaches fail to fully account for object deformation, elasticity, and tactile feedback, resulting in low grasping accuracy and success rates. On the other hand, tactile perception is able to help better understand the hardness, texture, and deformation process of an object, and provide important operational feedback. However, without an effective fusion strategy, tactile information alone is insufficient to achieve efficient object manipulation.

In recent years, rapid advances in multimodal fusion technology have provided a solution to this problem; by integrating visual, tactile, and language information, a multimodal model can achieve more comprehensive environmental perception and reasoning about manipulation plans. However, existing multimodal fusion techniques applied in the field of robotic interaction and the operation field still suffer from the following issues:

Insufficient cross-modal feature alignment: features from different modalities differ in representation format and semantic space, resulting in poor information fusion performance.

Limited dynamic planning and real-time adjustment capability: existing models exhibit weak robustness in action planning under dynamic environments when facing complex manipulation tasks.

Insufficient utilization of historical information: lack of modeling and storage of task history impairs the optimization and generalization capability of operation policies.

In addition, existing object manipulation approaches primarily rely on static perception data, such as image signals or tactile signals, and ignore dynamic changes in the object state and the environmental feedback during the actual operation. In particular, for the deformable object, achieving dynamic perception and decision-making through the multimodal fusion model to ensure the safety and stability of robotic operation remains a significant challenge.

### SUMMARY

An object of the present disclosure is to overcome the aforementioned drawbacks of existing technologies by providing a method for interaction operation control of a deformable object based on a vision-tactile-language-action multimodal model, which enhances cross-modal feature alignment capability, action planning accuracy, and task adaptability, enables dynamic adjustment of operation policies, and achieves more intelligent and precise manipulation of the deformable object.

One or more embodiments of the present disclosure provide a method for interaction operation control of a deformable object based on a vision-tactile-language-action multimodal model, including:
Encoding a visual image, tactile data, and language data for the deformable object to obtain a visual feature, a tactile feature, and a language feature;
Performing cross-modal feature alignment processing on the visual feature, the tactile feature, and the language feature to obtain a multimodal fusion feature;
Inputting the multimodal fusion feature into a large model for environment understanding;
Adopting a planning manner of ‘thinking-decision’ to iteratively perform action planning and execution; and
Repeating the above operation steps until completion of the interaction operation task of the deformable object.

### BRIEF DESCRIPTION OF THE DRAWINGS

The present disclosure will be further described by way of exemplary embodiments, which will be described in detail through the accompanying drawings. These embodiments are not limiting, and in these embodiments, the same numbers denote the same structures, wherein:

FIG. 1 is an exemplary flowchart illustrating a method for interaction operation control of a deformable object based on a vision-tactile-language-action multimodal model according to some embodiments of the present disclosure.

FIG. 2 is a schematic diagram illustrating an application framework of the method according to some embodiments of the present disclosure.

FIG. 3 is a schematic diagram illustrating an action planning process according to some embodiments of the present disclosure.

FIG. 4 is an exemplary flowchart illustrating repeated execution and updating of an operation policy according to some embodiments of the present disclosure.

### DETAILED DESCRIPTION

In the following detailed description, numerous specific details are set forth by way of examples in order to provide a thorough understanding of the relevant disclosure. Obviously, the drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and are not intended to limit the scope of the present disclosure. Unless obviously obtained from the context or the context illustrates otherwise, the same numeral in the drawings refers to the same structure or operation.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood that the operations of the flowcharts may be implemented not in order. Conversely, the operations may be implemented in an inverted order or simultaneously. Moreover, one or more other operations may be added to the flowcharts. One or more operations may be removed from the flowcharts.

The present disclosure will be described in detail below with reference to the accompanying drawings and specific embodiments.

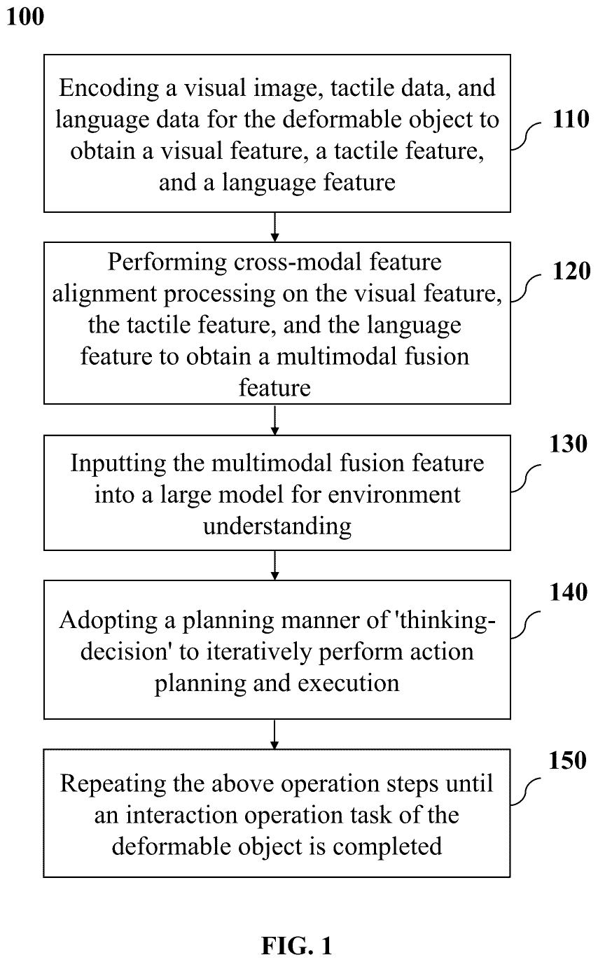

FIG. 1 is an exemplary flowchart illustrating a method for interaction operation control of a deformable object based on a vision-tactile-language-action multimodal model according to some embodiments of the present disclosure.

As shown in FIG. 1, the method for interaction operation control of the deformable object based on the vision-tactile-language-action multimodal model is executed by a processor, which may integrate the vision-tactile-language-action multimodal model, and includes the following operations.

In 110, encoding a visual image, tactile data, and language data for the deformable object to obtain a visual feature, a tactile feature, and a language feature.

The deformable object refers to an object whose geometric shape, internal structure, or physical properties are prone to significant change under external force. For example, the deformable object includes a flexible electronic component, a rubber ring, or the like.

The visual image refers to image data that characterizes a deformable object and the location of the deformable object. The visual image is able to reflect the shape, position, and size of the deformable object. For example, the visual image may be multi-angle views of the deformable object, local views when in contact with a robotic arm, etc.

In some embodiments, the visual image may be acquired by a camera, Lidar, etc., set up in a robotic arm or an operational environment. And the image format may be RGB, depth map, etc.

The operational environment refers to a spatial region and associated equipment conditions in which manipulation of the deformable object takes place. For example, the operational environment may be an automated workstation equipped with a robotic arm.

The tactile data refers to data characterizing surface properties and mechanical properties of the deformable object. For example, the tactile data may include a pressure distribution, a surface deformation, a texture of the deformable object, etc.

In some embodiments, the tactile data is acquired by a tactile sensor, a pressure sensor, or the like disposed at an end of the robotic arm.

The language data refers to textual or speech data describing an interaction operation task. For example, a user instruction such as “assemble flexible electronic component A onto device B.”

In some embodiments, the language data may be obtained by receiving voice input or text input from the user via the robotic arm.

The visual feature refers to a feature of information obtained by encoding the visual image, reflecting the content of the visual image. The visual feature includes semantic information such as a shape, a position, and a pose of the deformable object.

The tactile feature refers to a feature of information obtained by encoding the tactile data, reflecting surface properties and mechanical properties of the deformable object. The tactile feature includes semantic information such as the texture and the hardness of the deformable object.

The language feature refers to a feature of information obtained by encoding the language data, reflecting the semantic content. The language feature includes semantic information related to the user instruction.

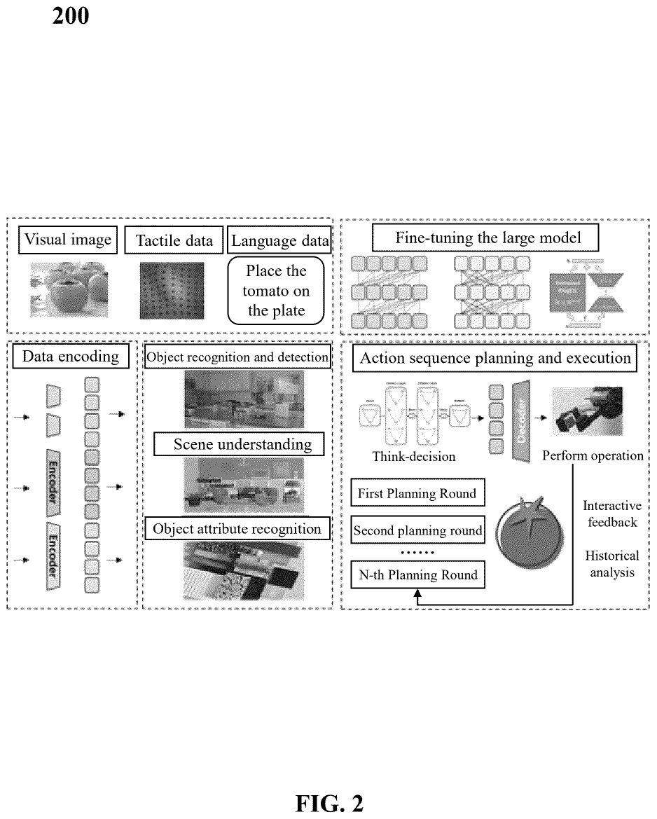

In some embodiments, encoding the visual image, the tactile data, and the language data for the deformable object refers to a process of converting the visual image, the tactile data, and the language data into feature representations. In some embodiments, the visual image encoding may include patching and linear mapping of the visual image. The tactile data encoding may include the extraction of the spatial feature and the time feature from the tactile signal. And the language data encoding may include semantic parsing of the language instructions. For example, the image data encoding may be implemented by a convolutional neural network or a Transformer model. The tactile data encoding may be implemented by a sensor data processing module. And the language data encoding may be implemented by a pre-trained language model. More descriptions regarding encoding may be found in FIG. 2 and the relevant descriptions thereof.

In 120, performing cross-modal feature alignment processing on the visual feature, the tactile feature, and the language feature to obtain the multimodal fusion feature.

The multimodal fusion feature refers to integrating a feature of information obtained by fusing a visual feature, a tactile feature, and a language feature within the same semantic space. For example, the multimodal fusion feature may be a combined vector including a visual feature, a tactile feature, and a language feature.

The cross-modal feature alignment processing refers to a process of mapping a visual feature, a tactile feature, and a language feature from different modalities into a unified semantic space and establishing semantic correspondences among the modalities, enabling unified processing of information from all modalities.

In some embodiments, the cross-modal feature alignment processing may be performed through a plurality of manners to obtain the multimodal fusion feature. For example, the cross-modal feature alignment processing may include using a projector or other approaches to align the visual feature, the tactile feature, and the language feature. More descriptions regarding this may be found in FIG. 2 and the relevant descriptions thereof.

In 130, inputting the multimodal fusion feature into a large model for environment understanding.

The large model includes any model capable of processing multimodal features and performing complex reasoning and decision-making. For example, LLM, MLLM, GPT-4, or the like.

In some embodiments, the large model may include the large language model Llama 2.

Environmental understanding refers to the identification and judgment of the entire operational environment. For example, determining which entities are present in the operational environment and what relationships exist among the entities.

In some embodiments, the large model may perform a plurality of types of environment understanding based on the multimodal fusion feature.

For example, the large model may leverage cross-modal reasoning capability to perform a comprehensive analysis on the multimodal fusion feature, and identify a pose, a deformation extent, and a force condition of the deformable object, thereby providing a basis for subsequent action planning and execution.

In some embodiments, the environment understanding includes object detection and recognition, scene understanding, instance segmentation, and object attribute recognition.

The object detection and recognition refer to the identification of deformable object(s) and obstacle(s) in the operational environment. For example, the object detection and recognition may include locating the deformable object and classifying its type.

The scene understanding refers to the identification and comprehension of semantic information and relationships among objects in an operational environment through language instructions or textual descriptions. For example, the scene understanding may include identifying an object relationship or an environmental structure in a scene.

The instance segmentation refers to the segmentation of the deformable object and the obstacle. For example, the instance segmentation may include segmenting the exact contour of the deformable object.

The object attribute recognition refers to the process of identifying object attributes. For example, the object attribute recognition may include identifying shape, texture, and hardness characteristics of the deformable object.

In some embodiments, the large model identifies a type, a position, and a boundary of the deformable object and an obstacle based on the visual feature portion of the multimodal fusion feature. The large model determines a relationship between the deformable object and the obstacle corresponding to the interaction operation task based on the language feature portion. The large model performs instance segmentation on the deformable object and the obstacle to generate respective contours. And the large model identifies physical attributes of the deformable object, such as a shape, a texture, and a hardness, based on the tactile feature portion.

In some embodiments of the present disclosure, key physical attributes of the deformable object, such as the material and the texture, are identified, and high-level semantic reasoning about an entire operation scene is performed, thereby providing accurate and rich prior knowledge for subsequent action planning and significantly enhancing targeting and reliability of the action planning.

In 140, adopting a planning manner of ‘thinking-decision’ to iteratively perform action planning and execution.

‘Thinking-decision’ refers to decomposing a complex interaction operation task into a series of intermediate steps. Before executing each action, the large model first analyzes a current state—that is, ‘thinking’—and then generates and selects a corresponding action based on the result of the analysis—that is, ‘decision’. For example, the ‘thinking-decision’ planning manner may include analyzing a current state before generating an action plan at each step.

The action planning refers to a temporal sequence composed of one or more actions and associated parameters. For example, the action planning may be “grasp object A with force 1, move to position B at speed 2, apply pressure with force 3, and hold for C seconds”.

The execution, also known as the action planning, refers to the conversion of an action plan into actual physical motion and interaction behavior by the robotic arm.

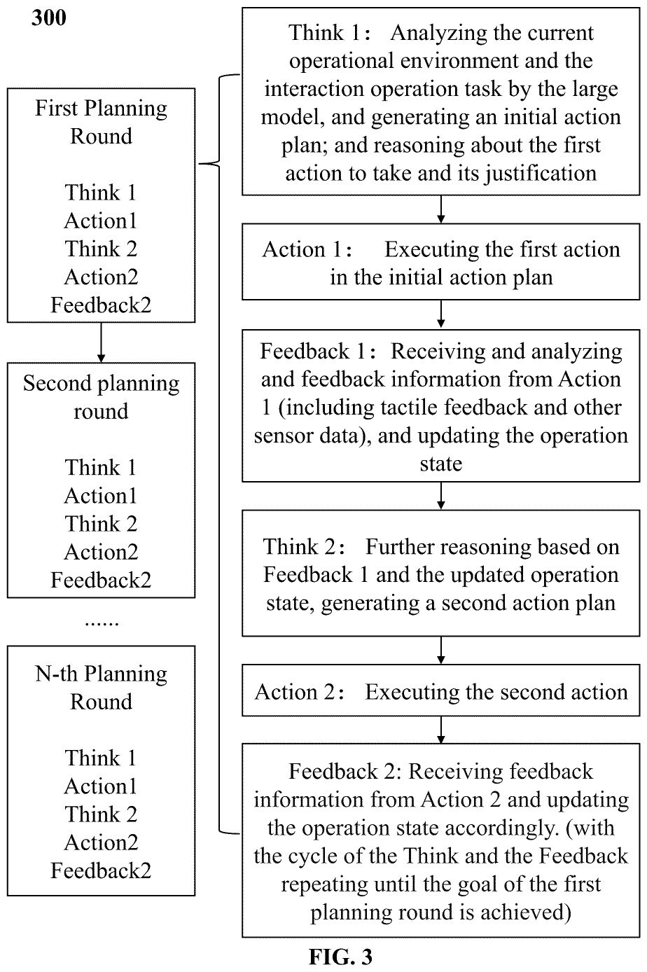

More descriptions regarding the action planning and execution using the ‘thinking-decision’ planning manner may be found in FIG. 2, FIG. 3, and the relevant descriptions thereof.

In 150, repeating the above operation steps until an interaction operation task of the deformable object is completed.

The interaction operation task refers to a task that the robotic arm is required to complete in response to a command issued by the user. For example, “fold fabric.”

In some embodiments, repeating the above operation steps includes using a Temporal Graph Network (TGN) for analyzing operation history and policy update, and performing time series modeling of the operation history based on time feature modeling. And dynamically capturing operation state change over time, based on environmental feedback-driven decision optimization, combining the TGN and a tactile signal, predicting a task completion probability, and adjusting an operation policy in real time, and preferentially executing the action planning with a high success rate.

The TGN refers to a neural network for processing time sequence graph data. In some embodiments, the TGN may model a temporal dependency relationship of the operation history. For example, the TGN may capture dynamic interaction between nodes through a graph attention mechanism.

The operation history refers to operations performed by the robotic arm on the deformable object in the past. The operation history may include the historical actions performed by the robotic arm and related data thereof.

The operation history analysis refers to an analysis of the operation history.

The policy update refers to an update of the action planning executed by the robotic arm on the deformable object.

The task completion probability refers to the success rate of completing the interaction operation task.

The time feature refers to a timestamp of executing the interaction operation task.

In some embodiments, the operation history analysis and the policy update include the following:

In 410, utilizing the TGN to perform time series modeling on the operation history based on the time feature modeling, and dynamically capture patterns of the operation state changing over time.

In some embodiments, the TGN treats the historical actions, the historical environmental feedback, the historical tactile signals, and the historical interaction operation task as nodes in a graph structure, with dependency relationships between different nodes represented as edges. By dynamically updating node states and edge relationships, the TGN performs the time series modeling of the operation history, captures the patterns of the operation state changing over time, and outputs the time series feature representation.

In 420, incorporating the time features into the large model to enable the large model to perceive changes in the operational environment and the operation state at different time points.

In some embodiments, the processor inputs the time series feature representation generated by the TGN into the large model, enabling the large model to perceive changes in the operational environment and changes in the operation state at different time points.

In 430, combining the TGN with the current tactile signal to predict the task completion probability.

In 440, prioritizing the action planning with a high success rate for execution based on the predicted task completion probability.

In 450, updating the operation policy based on new environmental feedback and input of the current tactile signal.

In some embodiments, the operation state is updated after each environmental feedback, and the operation policy is adjusted based on the new environmental feedback and the current tactile signal. In some embodiments, the TGN performs the time series modeling of the operation history through equation (1):

$${H}_{t} = TGN ( {H}_{t - 1} , {E}_{t} , {F}_{t} ) , \qquad ( 1 )$$

In equation (1), Hₜ denotes a current operation history feature, Hₜ₋₁ denotes an operation history feature of a previous step, Eₜ denotes a current environmental feedback, and Fₜ denotes a current tactile signal.

Perform the policy update through equation (2):

$${π}^{′} = arg {max}_{π} {P}_{success} ( {H}_{t} , {E}_{t} , {F}_{t} ) , \qquad ( 2 )$$

In equation (2), π′ denotes an optimized action planning, and P_{success} denotes a probability function of task success.

Conventional algorithms lack the capability of deep learning and memory regarding the historical tasks and the environmental changes when handling complex tasks. In some embodiments of the present disclosure, the TGN is combined to perform the time series modeling, analyze operation history, and optimize policies, thereby enabling real-time adjustment of the operation policy based on historical experience and the environmental feedback, and enhancing the precision and success rate of task execution.

In some embodiments of the present disclosure, multimodal information from vision, touch, language, and action are integrated, and an iterative ‘thinking-decision’ planning and execution approach is adopted to construct a complete closed-loop control framework for the deformable object, effectively addressing the challenge of coordinating perception and decision-making when the robots manipulate complex flexible objects in unstructured environments.

FIG. 2 is a schematic diagram illustrating an application framework of the method according to some embodiments of the present disclosure. The processor may implement the above-described method for interaction operation control of the deformable object based on the vision-tactile-language-action multimodal model to construct an application framework as illustrated in FIG. 2.

In some embodiments, encoding a visual image, tactile data, and language data for the deformable object to obtain a visual feature, a tactile feature, and a language feature includes:

Through a visual encoder and a tactile encoder, respectively, mapping the visual image and the tactile data of the deformable object to a visual embedding and a tactile embedding, and simultaneously mapping the language data to a language embedding, thereby extracting the visual feature, the tactile feature, and the language feature.

In some embodiments, the visual encoder refers to an encoding component configured to extract the visual feature. The tactile encoder refers to an encoding component configured to extract the tactile feature.

In some embodiments, the processor maps language data to a language embedding based on a language encoder. The language encoder refers to an encoding component configured to extract the language feature.

In some embodiments, both the visual encoder and the tactile encoder adopt a multi-layer Transformer architecture, and the visual feature and the tactile feature are extracted through the self-attention mechanism, while the language encoder employs the Transformer model to map language instructions to the language embedding. This process enables the extraction of the visual feature and the tactile feature of the object and captures key information such as shape, texture, and hardness.

The multi-layer Transformer architecture refers to a neural network architecture composed of a plurality of Transformer layers. For example, the multi-layer Transformer architecture may include an encoder-decoder architecture or a self-attention mechanism layer.

In some embodiments, the visual embedding, the tactile embedding, and the language embedding refer to vector representations of the image data, the tactile data, and the language data in an embedding space, respectively. For example, the visual embedding may be a feature vector extracted by the visual encoder, the tactile embedding may be a feature vector extracted by the tactile encoder, and the language embedding may be a semantic vector extracted by the language encoder.

In some embodiments, the visual encoder adopts a standard Vision Transformer architecture and is configured to divide an input visual image into fixed-sized patches, convert the patches into embedding vectors through linear mapping, and input the embedding vectors into a multi-layer, multi-head self-attention-based Transformer encoder to extract a global feature and a local feature. The tactile encoder adopts a dual-tower Transformer architecture. One tower is configured to model a spatial feature of the tactile data, and the other tower is configured to capture a temporal relationship of tactile signals.

The standard Vision Transformer architecture refers to a standard Transformer-based structure for visual feature extraction. For example, the standard Vision Transformer architecture may include segmenting an image into patches and generating embeddings through linear mapping.

The fixed-sized patches refer to fixed-sized blocks into which the visual image is divided. For example, the fixed-sized patches may include a 16×16 pixel image region.

The linear mapping refers to a process of mapping data into a new space through a linear transformation. For example, the linear mapping may include matrix multiplication or fully connected layer operations.

The embedding vector refers to a vector representation of an image patch in an embedding space. For example, an embedding vector may include a vectorized representation of an image patch, a tactile signal, or a language token.

The multi-layer multi-head self-attention mechanism refers to a Transformer encoder architecture that employs a multi-head self-attention mechanism. For example, the multi-layer multi-head self-attention mechanism may include a plurality of self-attention heads and a plurality of layers of feed-forward networks.

The global feature and the local feature refer to features representing global and local information extracted from data, respectively. For example, the global feature and the local feature may include an overall contour and a detailed texture of the image.

In some embodiments, the visual encoder may adopt a Vision Transformer (ViT) model. The visual encoder divides the visual image input to the ViT model into a plurality of fixed-sized image patches, and converts each Patch into a corresponding embedding vector through linear mapping. The visual encoder then inputs the embedding vectors, together with positional encodings, into the Transformer encoder including a plurality of layers of multi-head self-attention mechanisms, thereby simultaneously capturing information from both the global feature and the local feature of the visual image and ultimately outputting a comprehensive visual feature.

In some embodiments, the language encoder may adopt a standard Transformer model.

The dual-tower Transformer architecture refers to an architecture composed of two independent Transformer towers.

In some embodiments, both “tactile data” and “tactile signal” originate from raw acquisition information provided by tactile sensors. For ease of description and understanding, the term “tactile data” may be used when emphasizing its spatial distribution features, while the term “tactile signal” may be used when emphasizing its temporal sequence and dynamic variation features. The temporal relationship of the tactile signal refers to an associative feature of the tactile data varying over time. For example, the temporal relationship of the tactile signal may include a dynamic pattern or a temporal dependency of the tactile sequence.

In some embodiments, the tactile encoder adopts a dual-tower Transformer model to simultaneously process the spatial dimension and the temporal dimension of the tactile data. The dual-tower Transformer architecture may include the spatial feature tower and the time feature tower. The spatial feature tower is a sub-module configured to process the tactile data along the spatial dimension. For example, the spatial feature tower may perform operations such as convolution on the tactile data acquired from tactile sensors to model the spatial feature of the tactile data along the spatial dimension. The time feature tower refers to a sub-module configured to process the tactile data along the temporal dimension. For example, the time feature tower may input a sequence of tactile data into another Transformer encoder to capture the time feature of the tactile data along the time dimension.

In some embodiments of the present disclosure, the visual encoder divides the image into fixed-sized patches in the ViT manner and processes them through multi-head self-attention, thereby preserving both local texture and global deformation information within the same vector space. The tactile encoder employs the dual-tower Transformer architecture to separately extract the time feature and the spatial feature, which are then concatenated and fused. The resulting tactile feature thus incorporates both a spatial detail and a dynamic trend, providing richer information for subsequent decision-making.

In some embodiments, the visual embedding is also referred to as a visual global feature embedding or an image embedding.

In some embodiments, the visual embedding may be obtained by processing an input visual image through the visual encoder.

In some embodiments, an input visual image is divided into a plurality of fixed-sized image patches, each of which is converted into an embedding vector through linear mapping, and the embedding vector is then input into the visual encoder. The visual encoder employs the multi-head self-attention mechanism of the ViT model to extract the global visual feature and the local visual feature from the embedding vector and generate the visual embedding.

In some embodiments, the visual feature extraction adopts the standard Patch embedding procedure of ViT, dividing the input image I into N fixed-sized patches, as shown in equation (3):

$${P}_{i} = PatchEmbed ( I ) , i = 1 , … , N , \qquad ( 3 )$$

In equation (3), I denotes the input visual image, representing the two-dimensional pixel data of the current deformable object; N denotes the count of patches into which the image is divided; Pᵢ denotes the embedding vector of the i-th Patch, representing the feature vector after linear mapping.

The Patch embedding is encoded using a multi-head self-attention mechanism, as shown in equation (4):

$$Attention ( Q , K , V ) = softmax ( \frac{QK ′}{\sqrt{{d}_{k}}} ) V , \qquad ( 4 )$$

In equation (4), Q denotes the query vector, generated by applying a linear transformation to the Patch embeddings; K denotes the key vector, generated by applying a linear transformation to the Patch embeddings; V denotes the value vector, generated by applying a linear transformation to the Patch embeddings; dk denotes the dimensionality of the key vector, representing the size of the feature space.

The output global feature embedding V is obtained as shown in equation (5):

$$V = TransformerEncoder ( P ) , \qquad ( 5 )$$

In equation (5), V denotes the visual global feature embedding, representing the comprehensive visual feature of the image; P denotes the set of all Patch embeddings.

In some embodiments, the tactile embedding is also referred to as a tactile comprehensive feature embedding.

In some embodiments, the tactile embedding is obtained by processing the tactile data through the tactile encoder.

In some embodiments, the tactile feature extraction involves extracting the spatial feature Tₛ and the time feature Tₜ from the tactile data T, respectively, as shown in equation (6):

$${T}_{s} = Conv ( T ) , {T}_{t} = TransformerEncoder ( T ) , \qquad ( 6 )$$

In equation (6), T denotes the input tactile signal, representing the raw data collected through tactile sensors; Tₛ denotes the tactile spatial feature extracted through convolution operations; Tₜ denotes the tactile time feature extracted through the Transformer.

The two features are concatenated and passed through a fusion layer to obtain the tactile embedding T, as shown in equation (7):

$$T = Concat ( {T}_{s} , {T}_{t} ) , \qquad ( 7 )$$

In equation (7), T denotes the tactile comprehensive feature embedding, and the Concat denotes a feature concatenation operation.

In some embodiments, the language embedding is also referred to as a language feature embedding.

In some embodiments, the language encoder inputs the language data into the Transformer model and maps the language data to the feature vector representing semantic information, thereby obtaining the language embedding L.

In some embodiments, the language feature extraction involves encoding the language instruction (i.e., the language data) C into an embedding L using the Transformer model.

$$L = Transformer ( C ) , \qquad ( 8 )$$

In Equation (8), C denotes input natural language instruction, L denotes language feature embedding, representing the language semantic vector after Transformer encoding.

In some embodiments of the present disclosure, by employing the visual encoder of the Vision Transformer architecture and the tactile encoder of the dual-tower Transformer architecture, the system not only effectively captures both global visual semantics and local visual semantics of the deformable object, but also simultaneously models the spatial distribution and temporal dynamics of the tactile signal. This significantly enhances the comprehensive perception of object deformation, material properties, and contact states. Furthermore, through the multimodal fusion mechanism, synergistic understanding between visual and tactile information is strengthened, providing a reliable feature foundation for subsequent high-precision and highly robust interactive manipulation.

In some embodiments, performing cross-modal feature alignment processing on the visual feature, the tactile feature, and the language feature to obtain a multimodal fusion feature includes: utilizing a projector to map the visual embedding corresponding to the visual encoder, the tactile embedding corresponding to the tactile encoder, and the language embedding, to an input space of a language model, to achieve cross-modal alignment of multimodal features. In some embodiments, the projector adopts a linear transformation manner to convert the visual embedding and the tactile embedding into a format compatible with the input space of the language model.

The projector refers to a module configured to map the visual embedding and the tactile embedding into the input space of the language model. For example, the projector may include a linear layer or a cross-attention mechanism.

The input space of the language model refers to a feature space where the language model accepts input. For example, the input space of the language model may include a word embedding space or a semantic vector space.

Based on the projector, the visual embedding and the tactile embedding may be mapped together with the language embedding into the input space of the language model, thereby achieving cross-modal alignment of multimodal features—for example, ensuring that the visual feature and the tactile feature share consistent semantic representations with the language feature.

The linear transformation manner refers to a manner that performs data transformation through linear operations. For example, the linear transformation manner may include matrix multiplication or an affine transformation.

The format compatible with the input space of the language model refers to a data format that matches the input requirements of the language model. For example, such a format compatible with the input space of the language model may include a vector of a specific dimensionality or a sequence of tokens.

The projector employs the linear transformation manner to convert the visual embedding and the tactile embedding into a format compatible with the input space of the language model, ensuring a unified representation of multimodal information. For example, this unified representation may include a fused feature vector.

In some embodiments, the projector utilizes the cross-attention mechanism to map the visual embedding from the visual encoder and the tactile embedding from the tactile encoder, together with the language embedding, into the input space of the language model, thereby achieving the cross-modal feature alignment.

The cross-attention mechanism refers to a manner that leverages attention mechanisms to model interactions between different modalities. For example, the cross-attention mechanism may include query-key-value attention computations across modalities.

In some embodiments, the projector employs the cross-attention mechanism, using the visual embedding V and the tactile embedding T jointly as the key and the value, and the language embedding L as the query vector; a unified aligned feature embedding is then obtained through computation, ensuring efficient fusion of object and environmental information, as shown in equations (9)-(11):

$$M = CrossAttention ( L , V , T ) , \qquad ( 9 )$$

In equation (9), M denotes unified feature embedding after cross-modal alignment, L denotes the language embedding, V denotes the visual embedding, and T denotes the tactile embedding.

$$CrossAttention ( Q , K , V ) = softmax ( \frac{QK ′}{\sqrt{{d}_{k}}} ) V , \qquad ( 10 )$$

The output unified feature embedding is expressed as shown in equation (11):

$$M = Fusion ( L , V , T ) , \qquad ( 11 )$$

In some embodiments of the present disclosure, the cross-modal feature alignment is achieved by employing the cross-attention mechanism, enabling the language embedding to dynamically attend to key information in the visual and the tactile embedding. This more precisely associates operational intent with perceptual data, significantly enhancing semantic consistency and context sensitivity in multimodal fusion.

In some embodiments of the present disclosure, the projector is employed to map the visual embedding and the tactile embedding into the input space of the language model via linear transformation, thereby aligning multimodal features within a unified semantic space. This effectively bridges the differences in representation format and scale across modalities, providing subsequent processing stages with a structurally consistent and semantically coherent fused input, and consequently enhancing the efficiency and reliability of multimodal cooperative reasoning.

FIG. 3 is a schematic diagram illustrating an action planning process according to some embodiments of the present disclosure.

As shown in FIG. 3, in some embodiments, the “thinking-decision” planning approach is adopted to iteratively perform the action planning as follows: In the first planning round, the large model first performs reasoning (e.g., Think 1) based on the current environmental state and the interaction operation task, and generates an initial action plan that includes a first action (e.g., Action 1). The robotic arm executes Action 1, after which the large model receives feedback information (e.g., Feedback 1) and updates the operation state. The large model further performs reasoning based on Feedback 1 and the updated operation state, generating a second action plan, and executing the second action plan (e.g., Action 2). Feedback from Action 2 (e.g., Feedback 2) is received, and the operation state is updated again. This cycle of thinking, decision-making, execution, and state updating is repeated until the first planning round is completed. Upon completion of the first planning round, a second planning round begins, repeating the same iterative process until the entire interaction operation task is accomplished.

In some embodiments, the large model adopts the planning manner of the “thinking-decision” to iteratively perform the action planning and execution, including:

In 141, utilizing a large language model with backbone Llama 2 to generate the action planning for the operation state through a stepwise prediction, the large language model being the pre-trained language model based on a Transformer architecture, the action planning adopting an iterative manner through the planning manner of ‘thinking-decision’, including combining historical tasks, an environmental feedback, and a current tactile signal to generate a next action and evaluate an effect of the next action.

The large language model with backbone Llama 2 (also referred to as the large language model Llama 2) refers to a Llama 2 large language model serving as a core component. For example, the large language model with backbone Llama 2 may be configured for natural language understanding and action planning.

The pre-trained language model based on a Transformer architecture may include models from the BERT or GPT series.

The operation state refers to the interactive operation state between the robotic arm and the deformable object at the current time point. For example, at the current time point, the robotic arm has grasped the deformable object A at a position 1 with a grasping force 2.

In some embodiments, the operation state includes the pose and the grasping force of the robotic arm, as well as the state of the deformable object.

The action planning for the operation state refers to the process of generating an action plan according to the operation state. As an example, the action planning for the operation state may include planning the next action based on the environmental feedback. The stepwise prediction refers to a process of generating prediction results in a sequential, step-by-step manner. For example, the stepwise prediction may include iteratively generating each step of an action sequence.

The historical tasks refer to previously executed interaction operation tasks. In some embodiments, the historical tasks include all actions and associated data executed from the start to the completion of past interaction operation tasks, as well as historical visual features, historical tactile features, and historical language features.

The environmental feedback refers to real-time changes in the operational environment that occur after the robotic arm executes the action. As an example, changes in a shape or a pose of the deformable object. In some embodiments, the environmental feedback may be acquired via sensors arranged on the robotic arm and in the operational environment.

The tactile signal refers to a continuous sequence of the tactile data along the time dimension. In some embodiments, a tactile signal is obtained by ordering the tactile data along the time axis. The current tactile signal refers to the tactile data corresponding to the current time point.

The next action refers to an action generated by the large language model for execution by the robotic arm.

Evaluating the effect of the next action refers to estimating the impact of the robotic arm executing the next action on completing the interaction operation task. For example, when the interaction operation task is to move object A to position B, evaluating whether the next action C brings object A closer to position B.

In some embodiments, the large language model Llama 2 may combine the historical tasks, the environmental feedback, and the current tactile signal to generate the next action and evaluate the effects of the next action in a plurality of ways. In some embodiments, a feature vector is constructed based on the interaction operation task, the environmental feedback, and the current tactile signal. An action vector database is built from the historical tasks. The action vector database includes a plurality of reference vectors along with their corresponding actions and action-effect scores. Through vector matching, reference vectors similar to the feature vector are retrieved from the action vector database. The reference vector with the highest weighted sum of similarity and action-effect score is determined as the target vector, and the action and action-effect score corresponding to the target vector are determined as the next action and the effect of the next action, respectively.

In some embodiments, the processor may obtain an action-effect score corresponding to each action by means of sensor-based validation.

More details regarding additional approaches for Llama 2 to generate the next action and evaluate the effect of the next action are provided in the following description. In some embodiments, the large language model Llama 2 may be combined with the multimodal shared memory module to perform natural language understanding and action planning. The multimodal shared memory module forms the temporal knowledge base by recording the historical visual feature, the historical tactile feature, and the historical language feature of the historical tasks. During the action planning process, the multimodal shared memory module retrieves the historical tasks to assist the large language model Llama 2 in generating the action planning for the operation state.

The multimodal shared memory module is a module for storing and managing data. For example, the multimodal shared memory module may include a local storage unit or an external storage medium equipped with index-based retrieval functionality, or the like. The multimodal shared memory module is external to the large language model and interacts with the large language model Llama 2 via a data interface.

The natural language understanding refers to identifying a semantic or an intent of the language data. For example, through intent slot filling, a user instruction in the language data, such as “grasp block 1 at coordinate A” is parsed into a structured triplet (grasp, coordinate A, block 1).

The temporal knowledge base is a database storing multimodal features indexed by time, supporting data retrieval based on time. In some embodiments, the multimodal shared memory module forms the temporal knowledge base by arranging the historical visual feature, the historical tactile feature, and the historical language feature of the tasks in chronological order along a time axis.

In some embodiments, the large language model Llama 2 retrieves the historical language feature relevant to the interaction operation task from the temporal knowledge base constructed by the multimodal shared memory module, and combines the historical language feature with the historical visual feature and the historical tactile feature to understand the meaning of the historical language feature in the operational environment.

In some embodiments, during the action planning, the large language model may retrieve the historical language feature, the historical visual feature, and the historical tactile feature associated with the interaction operation task from the temporal knowledge base, and combine them with the environmental feedback and the current tactile signal to infer the next action.

In some embodiments, the large language model Llama 2 is fine-tuned through the low-rank adaptation technique LoRA. The fine-tuning performs parameter optimization by adding a product of two low-rank matrices to an original weight matrix of the large language model Llama 2. The dimensions of the two low-rank matrices are much smaller than the dimension of the original weight matrix. The action planning is generated through an action policy function, taking the current task history, the environmental feedback, and the current tactile signal as input, and an action with the largest output value of the action policy function is determined as the next action. The action policy is updated based on the current action policy and the action policy update amount.

The current task history refers to historical data of the interaction operation task up to the current moment. The current task history includes the historical language feature, the historical visual feature, the historical tactile feature, etc. In some embodiments, the current task history is retrieved from the temporal knowledge base using a current time point as an index.

The current action policy refers to a value, a probability, etc., of an action generated by Llama 2 at the current time point. The current action policy function refers to a mathematical function for calculating a value, a probability, etc., of each action. The action policy update amount refers to a change value of the action policy.

In some embodiments, Llama 2 may implement LoRA fine-tuned by adding the low-rank matrix adjustments to the original weight matrix W of the large model according to equation (12):

$${W}^{′} = W + A \cdot B , A ∈ {ℝ}^{d \times r} , B ∈ {ℝ}^{r \times d} \qquad ( 12 )$$

In equation (12), W denotes the original weight matrix, W′ denotes a fine-tuned weight matrix, A and B denote low-rank matrices for parameter optimization, r denotes a dimension of the low-rank matrices satisfying condition r«d, d denotes a dimension of the original weight matrix, and R denotes a real number field. The original weight matrix is the weight matrix of Llama 2 before fine-tuning. The low-rank matrix may include a decomposed matrix pair.

The low-rank adaptation technique LoRA refers to a technique that adjusts model weights through a low-rank matrix. In some embodiments, LoRA may be configured to fine-tune a pre-trained model to adapt to a specific task. For example, the dimensions of the low-rank matrix A and B may be adjusted according to model size and task complexity.

Llama 2 determines the next action using equation (13):

$${a}_{t + 1} = arg {max}_{a ∈ A} π ( a \vert {H}_{t} , {E}_{t} , {F}_{t} ) , \qquad ( 13 )$$

In equation (13), aₜ₊₁ denotes the next action, π denotes the action policy function, Hₜ denotes the current task history, Eₜ denotes the environmental feedback, and Fₜ denotes the current tactile signal. The action policy function refers to a function for generating the action policy. In some embodiments, the action policy function may output an action probability based on a state input. For example, the action policy function may be implemented by a neural network or a lookup table.

The Llama 2 updates the action policy using equation (14):

$$π ( {a}_{t + 1} ) = π ( {a}_{t} ) + Δπ ( {a}_{t} ) , \qquad ( 14 )$$

In equation (14), π(aₜ) denotes the current action policy, and Δπt(aₜ) denotes the action policy update amount. The action policy update amount may be calculated based on a feedback signal. For example, the action policy update amount may be determined through gradient descent or Monte Carlo ways.

The action planning of conventional algorithms is often accomplished through fixed rules or predefined models and lacks a dynamic adjustment mechanism with real-time environmental feedback. In contrast, some embodiments of the present disclosure introduce the multimodal shared memory module to record historical features of tasks and combine the fine-tuned Llama 2 large language model with feedback from the current tactile signal, employing an iterative “thinking-decision” planning manner. This enables real-time evaluation and adjustment of the plan after each action is generated, thereby enhancing flexibility and safety during the interaction process.

In some embodiments, the large language model Llama 2 may generate the next action and a corresponding confidence score by combining the historical tasks, the environmental feedback, and the current tactile signal. In response to the confidence score being not less than the first threshold, the next action is determined as an action to be executed. In response to the confidence score being less than the first threshold, the process proceeds to the next iteration of the action planning.

The confidence score refers to a quantitative assessment score of action reliability and may be represented numerically.

In some embodiments, the historical tasks, the environmental feedback, and the current tactile signal are input into the large language model Llama 2, and the Llama 2 generates a plurality of candidate actions along with task completion probabilities corresponding to the plurality of candidate actions. The candidate action with the highest task completion probability is determined as the next action, and the task completion probability corresponding to the next action is determined as the confidence score.

The first threshold is a metric for assessing the reliability of an action and is configured to determine whether the action may be executed.

In some embodiments, the first threshold is determined in a plurality of ways. For example, the first threshold is preset based on historical experience.

It is known that there are two cases: the confidence score is not less than a first threshold, and the confidence score is less than the first threshold. In some embodiments, Llama 2 outputs the next action along with the confidence score of the next action, and compares the confidence score against the preset first threshold. In response to the confidence score being greater than or equal to the first threshold, the next action is considered sufficiently reliable, and the robotic arm executes the action. In response to the confidence score being less than the first threshold, the next action is considered unreliable. Llama 2 discards the action, reacquires the current tactile signal, latest environmental feedback, and historical task information, generates a new next action and corresponding confidence score, and compares the confidence score with the first threshold. This process repeats iteratively until the next action with a confidence score not less than the first threshold is selected, and the robotic arm executes the next action.

In some embodiments, the first threshold is related to a task risk index. For example, the greater the task risk index, the higher the first threshold.

The task risk index is an indicator that characterizes the level of risk associated with completing the interaction operation task. In some embodiments, the task risk index may be a weighted sum of an object risk index, an action risk index, and an environment risk index.

The object risk index is an indicator that measures properties of the deformable object, such as fragility, vulnerability, and instability. For example, the object risk index is represented based on a numerical value of 0˜100, where a larger value indicates that the deformable object is more prone to tipping or deformation.

In some embodiments, the large language model may obtain the object risk index by querying a preset table based on the type, the material, and the size of the deformable object. The preset table is a mapping table that associates the type, the material, and the size of the deformable object with corresponding object risk indices. The preset table is constructed based on the historical data or the historical experience.

In some embodiments, the type, the material, and the size of the deformable object may be obtained from image data by an image recognition manner, such as a convolutional neural network. More descriptions regarding the image data may be found in FIG. 1 and the relevant descriptions thereof.

The action risk index is an indicator that measures the precision requirements and complexity of the action. For example, the action risk index may be represented by a numerical value ranging from 0 to 100, where a larger value indicates a more complex action.

In some embodiments, the action risk index may be obtained by performing normalization on the action precision, the grasping speed, and the grasping force, followed by a weighted summation. The normalization processing includes Min-Max normalization, etc. The weights for the weighted summation are determined based on historical experience.

In some embodiments, the grasping speed and the grasping force may be determined by output from the large language model. Based on the experimental data, a precision value is pre-assigned to each action type, and the precision value corresponding to the action is determined according to the type to which the action belongs.

The environment risk index is an indicator that measures the congestion level within the operational environment, the distance to sensitive areas, and surface stability. In some embodiments, the environment risk index may be obtained by performing normalization on the congestion level within the current operational environment, the distance to sensitive areas, and the flatness of the platform surface, followed by a weighted summation.

The sensitive area refers to an area where accidents are likely to occur. The congestion level is characterized based on the device density. The surface stability refers to whether the platform surface on which the object is placed is level, and may be characterized based on the flatness of the platform surface.

In some embodiments, the congestion level within the current operational environment, the distance to sensitive areas, and the flatness of the platform surface may be obtained through image recognition applied to the image data, and the sensitive areas may be pre-labeled manually.

In some embodiments of the present disclosure, the first threshold is dynamically determined based on the task risk index, enabling the conservativeness of decision-making to adapt automatically to the tasks of different risk levels, thereby enhancing operational safety.

In some embodiments, each iteration of the action planning further includes: taking the next action generated in a previous iteration as an action to be executed, and in response to the confidence score of the action to be executed being less than a second threshold, generating a plurality of candidate actions according to the operation state, the environmental feedback, the action to be executed, and a confidence score corresponding to the action to be executed, the plurality of candidate actions including an operation action and a sensing action, determining an information gain of the sensing action according to the operation state, the environmental feedback, the interaction operation task, the current tactile signal, and the sensing action, and determining a target action according to a task gain of the operation action and the sensing action and the information gain of the sensing action.

The second threshold is an indicator for assessing the reliability of the model and is configured to determine whether the large language model needs to take corrective measures. The second threshold is less than the first threshold.

More descriptions regarding the operation state and the environmental feedback may be found in FIG. 1, FIG. 2, and the relevant descriptions thereof.

The candidate action refers to a candidate that may serve as the target action for subsequent execution. In some embodiments, two cases are known in which the confidence score of the action to be executed is less than the second threshold, and the confidence score of the action to be executed is not less than the second threshold. And in response to the confidence score of the action to be executed being less than the second threshold, the processor may generate a plurality of candidate actions based on the operation state, the environmental feedback, the action to be executed, and their corresponding confidence scores, the plurality of candidate actions including the operation action and the sensing action.

The operation action refers to a physical action that directly aims to complete a task. For example, grasping an object.

The sensing action refers to an exploratory action performed to obtain more information about the operational environment or the deformable object. For example, “lightly poke”, “lightly push”, “shake”, “scan a surface”, etc.

In some embodiments, after inputting the operation state, the environmental feedback, the candidate action for execution, and the corresponding confidence score to the large language model Llama 2 (also referred to as the Llama 2), the Llama 2 analyzes, based on the operation state and the environmental feedback, a reason type that causes the low confidence score of the candidate action for execution. Based on the reason type, the Llama 2 retrieves a corresponding action set from the action mapping table and outputs the action set to obtain a plurality of candidate actions. Each candidate action is either the sensing action or the operation action. The action mapping table is a mapping table that associates reason types causing the low confidence score with corresponding robotic arm actions. The action mapping table is preset based on historical experience.

The information gain refers to the degree of reducing uncertainty of a system about a world state, and is configured to measure a cognitive improvement obtained by the large language model after executing a certain action. For example, after the robotic arm performs the action “lightly touch object A,” tactile sensor signals provide information about the surface hardness of object A, thereby reducing uncertainty regarding the physical properties of object A; thus, the tactile feedback corresponds to a high information gain.

In some embodiments, information obtained after executing the sensing action may be input into the large language model to output a new confidence score, and a difference between the new confidence score and the current confidence score may be used as the information gain of the sensing action. The current confidence score refers to the confidence score of the next action output by the large language model at the current time point.

In some embodiments, for each sensing action, the processor further obtains a corresponding information gain based on cluster analysis. For example, the cluster vectors may be constructed based on a plurality of historical operation states, the historical environmental feedbacks, the historical interaction operation tasks, and the historical sensing actions of the robotic arm. The target vector may be constructed based on the operation state, the environmental feedback, the interaction operation task, and the current sensing action. The cluster vectors and the target vector may be clustered using a manner, such as K-means clustering, to obtain a plurality of clusters. The cluster containing the target vector is identified as the target cluster, and a mean of labels corresponding to all cluster vectors in the target cluster is used as the information gain of the target vector.

The label of the cluster vector may be different between a new confidence score obtained after inputting information acquired by executing the historical sensing action into the large language model and the confidence score output by the large language model before executing the historical sensing action.

The task gain refers to the contribution of executing a certain action to a task completion degree.

In some embodiments, the task gain may be pre-assigned to each type of sensing action. The operation action and the interaction operation task may be input into another large model, and the task gain of the operation action may be obtained based on the output of the another large model. The another large model includes any model capable of evaluating the promotion effect of an action on an objective. For example, the another large model may be BERT, ROBERTa, etc. The another large model is independent of the large model configured for the environment understanding in 310 and the Llama 2 model.

The target action refers to an action finally executed in the current round of the action planning.

In some embodiments, the target action may be determined based on scores of the operation action and the sensing action, where the scores are derived from the task gain of the operation action, the task gain of the sensing action, and the information gain of the sensing action.

In some embodiments, the task gain of the operation action is used as the score of the operation action. The weighted sum of the task gain and the information gain of the sensing action is used as the score of the sensing action. The candidate action with the highest score is selected as the target action.

In some embodiments of the present disclosure, when the confidence score is too low, the sensing action is proactively generated, and decisions are made based on the information gain, enabling the system to reduce cognitive uncertainty through active exploration and thereby resolving planning stagnation caused by insufficient information.

In 142, during the operation, the multimodal fusion model is utilized to dynamically predict the grasp point and the placement point, control the robotic arm to execute the next action, and update the operation state. The multimodal fusion model employs the cross-modal alignment manner to fuse the visual feature, the tactile feature, and the language feature, generating the grasp point and the placement point relevant to the operation state. The multimodal fusion model controls the motion trajectory and the applied force of the robotic arm, and continuously optimizes interaction with the deformable object based on the environmental feedback and the current tactile signal, thereby preventing damage or excessive deformation of the deformable object.

The multimodal fusion model refers to a model capable of fusing multimodal features. For example, OpenVLA, Perceiver IO, RT-2, etc.

The grasp point and the placement point refer to positions where the robotic arm grasps and places the deformable object, respectively, and are both characterized based on three-dimensional coordinates.

In some embodiments, the multimodal fusion model adopts the cross-modal alignment manner, such as the cross-attention mechanism, to fuse the visual feature, the tactile feature, and the language feature within a unified semantic space. Based on the fused representation, a regression network or similar algorithm predicts the grasp point and the placement point corresponding to the operation state. Based on the grasp point and the placement point, a motion trajectory of the robotic arm is computed using an inverse kinematics algorithm or a similar algorithm. Based on the hardness of the deformable object obtained by the large model through the environment understanding in 130, the grasping force is determined. The robotic arm then executes the next action according to the determined grasp point, the placement point, the motion trajectory, and the grasping force. During action execution, the robotic arm simultaneously acquires the operation state, the environmental feedback, and the tactile signal in real time via the sensors. The multimodal fusion model continuously adjusts the grasping force and the pose of the robotic arm in real time based on the environmental feedback and the tactile signal.

In some embodiments, the multimodal fusion model may predict the grasp point and the placement point through a Predict function based on the visual embedding, the tactile embedding, and the language embedding. The multimodal fusion model may determine an adjusted grasping force of the robotic arm through an Adaptive function based on the current tactile signal. The multimodal fusion model may determine an adjusted pose of the robotic arm through a Pose function based on the current tactile signal.

The grasping force refers to the magnitude of the force with which the robotic arm grasps the deformable object. The pose of the robotic arm refers to a position and a posture of the robotic arm when grasping the deformable object.

In some embodiments, the multimodal fusion model predicts the grasp point and the placement point using equation (15), that is, the Predict function is expressed as follows:

$$G , P = Predict ( V , T , L ) , \qquad ( 15 )$$

In equation (15), G denotes a predicted grasp point, P denotes a predicted placement point, and V,T,L denote the visual embedding, the tactile embedding, and the language embedding, respectively.

The adjusted grasping force of the robotic arm is determined using equation (16), that is, the Adaptive function and the Pose function are expressed as follows:

$${F}_{g} = Adaptive ( {F}_{t} ) , θ = Pose ( {F}_{t} ) , \qquad ( 16 )$$

In equation (16), F_{g} denotes the adjusted grasping force, θ denotes the adjusted pose of the robotic arm, and Fₜ denotes the tactile signal.

Conventional object grasping ways often neglect real-time feedback for adjustment. In some embodiments of the present disclosure, the multimodal fusion model dynamically predicts the grasp point and the placement point, controls the robotic arm in real time to perform interaction operations with the object, and adjusts the grasping force and the pose based on tactile feedback. This enables immediate adaptation to real-time environmental changes, thereby improving task success rate and operational precision, and ensuring safe manipulation of the deformable object.

In some embodiments of the present disclosure, the environmental feedback and the current tactile signal are continuously configured to optimize interaction behavior with the object, ensuring that the robotic arm achieves dynamic, closed-loop control during action execution. The multimodal fusion model employs the cross-modal alignment manner to fuse visual, tactile, and language information, generating the grasp point and the placement point relevant to the operation state. Based on the grasp point and the placement point, the multimodal fusion model controls the motion trajectory and the applied force of the robotic arm. By continuously incorporating the environmental feedback and the tactile signal, the interaction behavior with the object is iteratively refined, and the grasping force and the pose are adaptively adjusted, thereby effectively preventing damage or excessive deformation of the deformable object.

In the aforementioned operation 141, the large language model Llama 2 is fine-tuned using the low-rank adaptation technique (LowRank Adaptation, LoRA) to enhance its capability in generating action plans for interaction scenarios involving the deformable object. By integrating the historical tasks, the environmental feedback, and the tactile signal, the Llama 2 reasons about the current state of the object and generates a specific interaction action plan.

In some embodiments, the large language model Llama 2 is fine-tuned using an iterative “thinking-decision” planning manner, which progressively generates an action plan for interacting with the object and incorporates tactile feedback at each step to evaluate and adjust the plan.

The fine-tuned Llama 2 serves as the core for the natural language understanding and the action planning. By integrating with the multimodal shared memory module, it records visual, tactile, and language features involved in tasks and constructs the temporal knowledge base. During the action planning phase, the model retrieves the related feature of the historical tasks from the memory module to support reasoning about the current state, thereby enhancing interaction accuracy and system safety.

In the aforementioned operation 142, the multimodal fusion model dynamically predicts the grasp point and the placement point, controls the robotic arm in real time to execute interaction operations with the object, and adjusts the grasping force and the pose based on the tactile feedback, ensuring safe manipulation of the object.

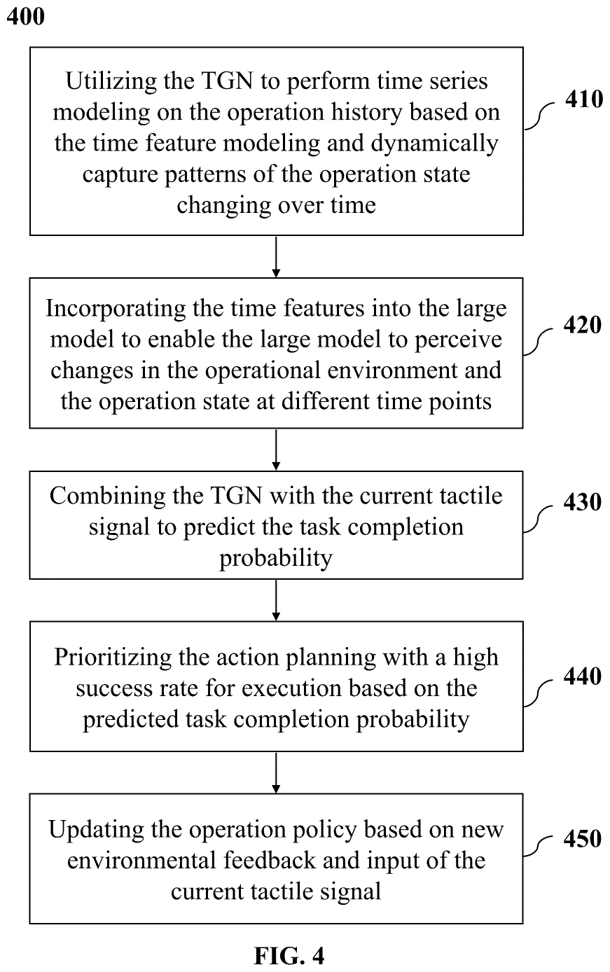

In the aforementioned operation 450, as shown in FIG. 4, the model performs operational history analysis and the policy update through a Temporal Graph Neural Network (TGN). The TGN models the time feature of the operation history and dynamically captures patterns of changes in the operation state over time. On this basis, the system integrates the environmental feedback for decision optimization, utilizes the TGN and tactile signals to predict task completion probability, and dynamically adjusts the operation policy in real time to prioritize execution of the action plan with the high success rate.

In some embodiments, the during the operation process, utilizing the multimodal fusion model adopting the cross-modal alignment manner to fuse the visual feature, the tactile feature, and the language feature, dynamically predicting the grasp point and the placement point, controlling the robotic arm to execute the next action and updating the operation state, and adjusting the grasping force and the pose of the robotic arm according to the environmental feedback and the current tactile signal includes: utilizing the multimodal fusion model adopting the cross-modal alignment manner to fuse the visual feature, the tactile feature, and the language feature, and predicting the grasp point and the placement point related to the operation state, controlling the robotic arm to perform the operation and updating the operation state based on the grasp point and the placement point, during the robotic arm performing the operation, determining the pose and the grasping force of the robotic arm according to the tactile signal every second cycle, controlling the robotic arm to move to the pose and grasp the deformable object with the grasping force based on the pose and the grasping force.

More descriptions regarding the multimodal fusion model, the cross-modal alignment manner, the visual feature, the tactile feature, the language feature, the grasp point, the placement point, the tactile signal, and control of the robotic arm to perform operations and update the operation state may be found in FIG. 2, FIG. 3 and the relevant descriptions thereof.

The second cycle refers to a time interval for periodically determining the grasp posture and the grasping force. In some embodiments, the second cycle may be set manually based on experience. For example, the duration of the second cycle may be set to 100 ms, 200 ms, or other values.

In some embodiments, during execution of the operation by the robotic arm, the tactile signal from the tactile sensor is read at intervals of the second cycle. Based on the tactile signal, the large model analyzes the spatial distribution pattern of the tactile signal across the sensor array to determine the grasp posture and performs aggregation on the signal amplitudes to compute the grasping force. This enables real-time determination of the current grasp posture of the robotic arm relative to the object and the actual grasping force. The robotic arm is then controlled to move along the motion trajectory to the grasp posture and grasp the deformable object, based on the determined grasp posture and grasping force. More descriptions regarding the determination of the pose and the grasping force of the robotic arm may be found in operation 142 and the relevant descriptions thereof.

In some embodiments of the present disclosure, the robotic arm moves toward the predicted grasp point. At intervals of the second cycle, the robotic arm recalculates the grasp posture and the grasping force based on the latest tactile signals and performs immediate adjustments. This realizes closed-loop fine-grained control across perception, decision-making, and execution. A plurality of corrections of contact states occur within a single grasping action. Grasping failure probability caused by object slippage or local collapse is reduced. The stability and success rate of operations on the deformable object increase.

In some embodiments, during execution of each round of the action planning, the processor determines the grasping force range at intervals of the first cycle based on the task phase and the grasp posture. In response to the current grasping force being outside the grasping force range, the robotic arm is controlled to adjust the current grasping force to within the grasping force range, and the action to be executed is executed. In response to the current grasping force being within the grasping force range, the robotic arm is controlled to execute the action to be executed with the current grasping force.

The first cycle refers to a time interval for periodically determining the grasping force range. In some embodiments, the first cycle may be set manually based on experience. For example, the duration of the first cycle may be set to 3 s, 5 s, 10 s, or other values.

The task phase refers to the current operation stage. For example, the task phase may be an exploratory touch, a stable grasping, a movement, a placement, etc.

The grasp posture refers to a specific posture and contact position of a robot grasping the object. For example, the grasp posture may be grasping a broad surface of the object or a fragile corner, etc.

The grasping force refers to a magnitude of the force applied by the robot to the object during the grasping process.

The grasping force range refers to an allowable interval of the grasping force that the object safely withstands.

In some embodiments, the grasping force range may be obtained through a first vector database. The first vector database refers to a database configured to determine the grasping force range.

The first vector database contains a plurality of historical task phases and the historical grasping poses, along with the corresponding grasping force range and the grasping effect. The processor generates a plurality of feature vectors based on a plurality of historical task phases and historical grasp postures. In a plurality of historical grasps corresponding to the feature vector, the grasping force range from a plurality of historical grasps where the grasping effect exceeds an effect threshold is used as the label corresponding to the feature vector. The processor constructs the target vector based on the current task phase and the current grasp posture.

The grasping effect refers to an indicator for characterizing a success degree of one grasp. In some embodiments, the grasping effect may be determined by performing a weighted summation on an object deformation amount and a relative displacement between the object and the robotic arm. In some embodiments, the object deformation is obtained by monitoring the geometric deformation of the object during the grasping using the tactile sensor or the vision system. Relative displacement between the object and the robotic arm is acquired using the robotic arm joint encoder or the visual tracking system. The weight coefficient of the object deformation amount is negative. The effect threshold may be set manually based on experience.

In some embodiments, the processor retrieves, from the first vector database, a plurality of feature vectors with a similarity to the target vector greater than the similarity threshold. The union of the grasping force ranges corresponding to the plurality of feature vectors is used as the grasping force range corresponding to the target vector.

In some embodiments, the grasping force range is related to the confidence score of the action to be executed.

More descriptions regarding the confidence score of the action to be executed may be found in FIG. 2 and the relevant descriptions thereof.

If the confidence score of the action to be executed is lower, a corresponding similarity threshold is smaller when matching the target vector with the feature vector.

In some embodiments, after the grasping force range is obtained through matching in the first vector database, the processor may dynamically tighten the grasping force range based on the confidence score of the action to be executed. For example, if the grasping force range obtained based on vector matching is (10, 20), and the confidence score of the action to be executed is lower than the confidence score threshold, the grasping force range may be contracted to a smaller sub-interval, such as (12, 17.5).

In some embodiments of the present disclosure, by associating the grasping force range with the confidence score of the action to be executed, the system reduces the risk of excessive pressure when the confidence score is low due to uncertainty in environmental or object state perception. Without modifying hardware, the system automatically adopts a more conservative grasping force strategy, effectively preventing object damage or operation failure caused by misjudgment, thereby further enhancing safety and robustness in interactions with the deformable object.

It is known that the current grasping force is either outside or within the grasping force range. In some embodiments, before executing the action to be executed, the processor determines whether the current grasping force of the robotic arm lies within the determined grasping force range. In response to the current grasping force exceeding the grasping force range, the processor first adjusts the grasping force of the robotic arm to fall within the grasping force range before executing the action to be executed. In response to the current grasping force already lying within the grasping force range, the processor directly executes the action to be executed using the current grasping force of the robotic arm.

In some embodiments of the present disclosure, during action execution, the grasping force range is dynamically determined at regular intervals based on the task phase and the grasp posture, and the current grasping force is verified and adjusted in real-time. This ensures that the robotic arm always operates the deformable object within a safe and appropriate force range, effectively preventing object damage caused by excessive force or operation failure caused by insufficient force, thereby significantly enhancing the adaptability, stability, and safety of the interaction operation.

In summary, in some embodiments of the present disclosure, by integrating visual, tactile, and language information and leveraging the Transformer architecture, LoRA, and the TGN, the system enhances multimodal feature alignment capability, action planning accuracy, and task adaptability. This improves generalization performance in interactions with the deformable object, enabling effective execution of the deformable object manipulation tasks across diverse complex scenarios, dynamic adjustment of operation policy, and more intelligent and precise manipulation of the deformable object.

Some embodiments of the present disclosure have the following advantages:
Multimodal fusion: The conventional algorithms typically treat vision, touch, and language as independent inputs. In contrast, the present disclosure maps visual, tactile, and language features into a unified embedding space and employs the cross-attention mechanism for cross-modal alignment, ensuring efficient information fusion across modalities. This multimodal fusion capability not only enhances perception of complex object attributes such as shape, texture, and hardness, but also improves system adaptability in multi-task and complex environments.
Adaptive action planning: The action planning of conventional algorithms often relies on fixed rules or predefined models and lacks a dynamic adjustment mechanism based on real-time environmental feedback. In contrast, the present disclosure combines the fine-tuned Llama 2 large language model with tactile signal feedback and employs an iterative “thinking-decision” planning manner. This enables real-time evaluation and adjustment of the action plan after each step, thereby enhancing flexibility and safety during interaction.
Enhanced tactile understanding: Conventional tactile perception typically relies on raw tactile sensor data and lacks the capability to deeply interpret tactile signals. The present disclosure employs the dual-tower Transformer architecture to separately model the spatial feature and the temporal relationship of the tactile data. By leveraging multi-head self-attention mechanisms, the system extracts the deep tactile feature, enabling more accurate capture of the shape, hardness, and other physical properties of the object. This effectively mitigates the risk of object damage or excessive deformation during manipulation.
Real-time dynamic adjustment: Conventional object grasping ways often neglect real-time feedback for adjustment. In contrast, the present disclosure utilizes the multimodal fusion model to dynamically predict the grasp point and the placement point during the operation, control the robotic arm in real time to execute actions, and continuously optimize interaction behavior with the object based on the environmental feedback and the tactile signal. This characteristic enables the present disclosure to make immediate adjustments according to real-time environmental changes, improving the task completion probability and the operation precision.
Enhanced task history understanding and optimization: The conventional algorithms lack the capability to deeply learn from and retain memory of the historical tasks and the environmental change when handling complex tasks. In contrast, the present disclosure introduces the multimodal shared memory module to record visual, tactile, and language features from the historical tasks, and integrates the Temporal TGN for time series modeling. This enables analysis of the operational history and the optimization of strategies. Consequently, the operation policy can be adjusted in real time based on the historical experience and the environmental feedback, enhancing the precision and the high success rate of the task execution.

It should be noted that the above descriptions are merely provided for the purposes of illustration and not intended to limit the scope of the present disclosure. For persons having ordinary skills in the art, multiple variations and modifications may be made under the teachings of the present disclosure. However, those variations and modifications do not depart from the scope of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. Furthermore, the particular features, structures, or characteristics may be combined as suitable in one or more embodiments of the present disclosure.

Similarly, it should be appreciated that in the foregoing description of embodiments of the present disclosure, various features are sometimes grouped together in a single embodiment, figure, or description thereof for the purpose of streamlining the disclosure, aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teachings of the present disclosure. Accordingly, the embodiments of the present disclosure are not limited to the embodiments introduced and described in the present disclosure explicitly.

What is claimed is:

1. A method for interaction operation control of a deformable object based on a vision-tactile-language-action multimodal model, executed by a processor, comprising:
encoding a visual image, tactile data, and language data for the deformable object to obtain a visual feature, a tactile feature, and a language feature;
performing cross-modal feature alignment processing on the visual feature, the tactile feature, and the language feature to obtain a multimodal fusion feature;
inputting the multimodal fusion feature into a large model for environment understanding;
adopting a planning manner of ‘thinking-decision’ to iteratively perform action planning and execution; and
repeating the above operation steps until an interaction operation task of the deformable object is completed.

2. The method according to claim 1, wherein the encoding the visual image, the tactile data, and the language data for the deformable object to obtain the visual feature, the tactile feature, and the language feature includes:
mapping the visual image and the tactile data of the deformable object to a visual embedding and a tactile embedding respectively through a visual encoder and a tactile encoder, and simultaneously mapping the language data to a language embedding, thereby extracting the visual feature, the tactile feature, and the language feature.

3. The method according to claim 2, wherein the visual encoder adopts a standard Vision Transformer architecture, and is configured to divide the visual image into patches of fixed-sized, convert the patches into embedding vectors through linear mapping, and input the embedding vectors into a Transformer encoder with a multi-layer multi-head self-attention mechanism to extract a global feature and a local feature; and
the tactile encoder adopts a dual-tower Transformer architecture, wherein one tower is configured to model a spatial feature of the tactile data, and another tower is configured to capture a temporal relationship of tactile signals.

4. The method according to claim 2, wherein the performing cross-modal feature alignment processing on the visual feature, the tactile feature, and the language feature to obtain the multimodal fusion feature includes:
utilizing a projector to map the visual embedding corresponding to the visual encoder, the tactile embedding corresponding to the tactile encoder, and the language embedding, to an input space of a language model, to achieve cross-modal alignment of multimodal features, wherein the projector adopts a linear transformation manner to convert the visual embedding and the tactile embedding into a format compatible with the input space of the language model.

5. The method according to claim 2, wherein the performing cross-modal feature alignment processing on the visual feature, the tactile feature, and the language feature includes:
utilizing a projector, adopting a cross-attention mechanism to map the visual embedding corresponding to the visual encoder, the tactile embedding corresponding to the tactile encoder, and the language embedding to an input space of a language model, to achieve cross-modal alignment of multimodal features.

6. The method according to claim 1, wherein the environment understanding includes object detection and recognition, scene understanding, instance segmentation, and object attribute recognition.

7. The method according to claim 1, wherein the adopting the planning manner of ‘thinking-decision’ to iteratively perform the action planning and execution includes:
utilizing a large language model with backbone Llama 2 to generate an action planning for a operation state through stepwise prediction, the large language model being a pre-trained language model based on a Transformer architecture, the action planning adopting an iterative manner through the planning manner of ‘thinking-decision’, including combining historical tasks, environmental feedback, and a current tactile signal to generate a next action and evaluate an effect of the next action; and
during an operation process, utilizing a multimodal fusion model adopting a cross-modal alignment manner to fuse the visual feature, the tactile feature, and the language feature, dynamically predicting a grasp point and a placement point, controlling a robotic arm to execute the next action and updating the operation state, and adjusting a grasping force and a pose of the robotic arm according to the environmental feedback and the current tactile signal.

8. The method according to claim 7, wherein the large language model combines a multimodal shared memory module to perform natural language understanding and the action planning, the multimodal shared memory module forms a temporal knowledge base by recording a historical visual feature, a historical tactile feature, and a historical language feature of historical tasks, and during a process of the action planning, the multimodal shared memory module retrieves the historical tasks to assist the large language model in generating the action planning for the operation state;
the large language model is fine-tuned through a low-rank adaptation technique (LoRA), adding a product of two low-rank matrices to an original weight matrix of the large language model, dimensions of the two low-rank matrices being much smaller than a dimension of the original weight matrix;
the action planning is generated through an action policy function, taking a current task history, the environmental feedback, and the current tactile signal as input, and determining an action with a largest output value of the action policy function as the next action; and
the large language model updates a current action policy based on the current action policy and an action policy update amount.

9. The method according to claim 7, wherein the combining the historical tasks, the environmental feedback, and the current tactile signal to generate the next action and evaluate the effect of the next action includes:
combining the historical tasks, the environmental feedback, and the current tactile signal to generate the next action and a confidence score corresponding to the next action;
in response to the confidence score being not less than a first threshold, determining the next action as an action to be executed; or
in response to the confidence score being less than the first threshold, entering a next iteration of the action planning.

10. The method according to claim 9, wherein the first threshold is related to a task risk index.

11. The control method according to claim 9, wherein each iteration of the action planning further includes:
taking the next action generated in a previous iteration as an action to be executed, and in response to the confidence score of the action to be executed being less than a second threshold, generating a plurality of candidate actions according to the operation state, the environmental feedback, the action to be executed, and a confidence score corresponding to the action to be executed, the plurality of candidate actions including an operation action and a sensing action;
determining an information gain of the sensing action according to the operation state, the environmental feedback, the interaction operation task, the current tactile signal, and the sensing action; and
determining a target action according to a task gain of the operation action and the sensing action and the information gain of the sensing action.

12. The method according to claim 7, wherein the during the operation process, utilizing the multimodal fusion model adopting the cross-modal alignment manner to fuse the visual feature, the tactile feature, and the language feature, dynamically predicting the grasp point and the placement point, controlling the robotic arm to execute the next action and updating the operation state, and adjusting the grasping force and the pose of the robotic arm according to the environmental feedback and the current tactile signal includes:
predicting the grasp point and the placement point based on the visual embedding, the tactile embedding, and the language embedding through a Predict function;
determining an adjusted grasping force of the robotic arm based on the current tactile signal through a Adaptive function; and
determining an adjusted pose of the robotic arm based on the current tactile signal through a Pose function.

13. The method according to claim 7, wherein the during the operation process, utilizing the multimodal fusion model adopting the cross-modal alignment manner to fuse the visual feature, the tactile feature, and the language feature, dynamically predicting the grasp point and the placement point, controlling the robotic arm to execute the next action and updating the operation state, and adjusting the grasping force and the pose of the robotic arm according to the environmental feedback and the current tactile signal includes:
utilizing the multimodal fusion model adopting the cross-modal alignment manner to fuse the visual feature, the tactile feature, and the language feature, and predicting the grasp point and the placement point related to the operation state;
controlling the robotic arm to perform an operation and updating the operation state based on the grasp point and the placement point;
during the robotic arm performing the operation, determining the pose and the grasping force of the robotic arm according to the current tactile signal every second cycle; and
controlling the robotic arm to move to the pose and grasp the deformable object with the grasping force based on the pose and the grasping force.

14. The method according to claim 1, wherein when performing each iteration of the action planning and execution, the method further comprises:
determining a grasping force range according to a task phase and a grasp posture every first cycle;
in response to a current grasping force being outside the grasping force range, controlling the robotic arm to adjust the current grasping force to within the grasping force range, and executing an action to be executed; or
in response to the current grasping force being within the grasping force range, controlling the robotic arm to execute the action to be executed with the current grasping force.

15. The method according to claim 14, wherein the grasping force range is related to a confidence score of the action to be executed.

16. The method according to claim 1, wherein the above operation steps include:
using a Temporal Graph Network (TGN) for analyzing operation history and policy update, and performing time series modeling of the operation history based on time feature modeling; and
dynamically capturing operation state change over time, based on environmental feedback-driven decision optimization, combining the TGN and a tactile signal, predicting a task completion probability and adjusting an operation policy in real time, and preferentially executing the action planning with a high success rate.
